(19) United States
(12) Patent Application Publication
(10) Pub. No.: US 2026/0318243 A1
(43) Pub. Date: Oct. 15, 2026

(54) DEVICE AND METHOD FOR MONITORING FREEZING OF AN INTERCOOLER IN A VEHICLE AND A VEHICLE AND A STORAGE MEDIUM INCLUDING THE SAME

(71) Applicants: HYUNDAI MOTOR COMPANY, Seoul (KR); KIA CORPORATION, Seoul (KR)

(72) Inventors: Han Gyeol Park, Hwaseong-si (KR); JeongEui Kong, Hwaseong-si (KR)

(73) Assignees: HYUNDAI MOTOR COMPANY, Seoul (KR); KIA CORPORATION, Seoul (KR)

(21) Appl. No.: 19/337,286

(22) Filed: Sep. 23, 2025

(30) Foreign Application Priority Data
Apr. 9, 2025 (KR) 10-2025-0046031

(51) Int. Cl. F02B 29/04

(52) U.S. Cl. CPC F02B 29/0493; F02B 29/04; F02B 29/0475

(57) ABSTRACT

A device for monitoring freezing of an intercooler in a vehicle includes a controller. The controller is configured to receive condition monitoring data including temperature data of a sensor unit of the vehicle including the intercooler. The controller is further configured to determine and change a degree of freezing progress of a plurality of freezing stages based on a process in which freezing progresses in the intercooler, according to the condition monitoring data. The controller is further configured to output the intercooler freezing monitoring data based on the degree of freezing progress.

### CROSS-REFERENCE TO RELATED APPLICATION(S)

This application claims the benefit of and priority to Korean Patent Application No. 10-2025-0046031 filed on Apr. 9, 2025 in the Korean Intellectual Property Office, the entire contents of which are incorporated herein by reference.

### TECHNICAL FIELD

The present disclosure relates to a device and a method for monitoring freezing of an intercooler in a vehicle and a vehicle and a storage medium including the same.

### BACKGROUND

In general, the engine system of a vehicle may be equipped with an exhaust gas recirculation (EGR) device for recirculating a portion of the exhaust back into the intake line. The exhaust gas recirculation (EGR) device may include a high-pressure EGR unit recirculating exhaust gases in front of the catalyst and a low-pressure EGR unit recirculating exhaust gases in the rear of the catalyst.

In addition, the engine system may include an intercooler for cooling the intake formed by compressing the recirculated exhaust of the low-pressure EGR unit and fresh air with a turbocharger and supplying the intake to the intake manifold of the engine.

During the process of cooling the intake in the intercooler, saturated water vapor in the low-pressure EGR gas condenses to generate condensate. In an environment with low ambient temperature, such as during winter, or high humidity, such as during a rainy season, the condensate may freeze and block the flow path of the intake, causing a warning light to turn on or a failure to start the engine while driving. For example, in some regions (for example, Northern Europe, Russia), winter temperatures may have high humidity and temperatures may alternate between sub-zero and above-zero, and thus the possibility of intercooler freezing may be relatively higher than in other regions.

Accordingly, vehicles may be brought into a vehicle service center (or repair shop), but the frozen condensate may naturally melt due to environmental factors and/or engine heat. Based on the freezing and thawing of a delivered vehicle, the vehicle service center (or repair shop) may have difficulty finding the cause of the delivered vehicle's warning light to turn on or the cause of the engine to malfunction and may needlessly replace other normal components (for example, turbocharger) or consume unnecessary service/maintenance time. The subject matter described in this background section is intended to promote an understanding of the background of the disclosure and thus may include subject matter that is not already known to those of ordinary skill in the art. The statements in this section merely provide background information related to the present disclosure and may not constitute prior art.

### SUMMARY

An aspect of the present disclosure aims to provide a device and a method for monitoring freezing of an intercooler in a vehicle and a vehicle and a storage medium including the same. The process of freezing in the intercooler (for example, freezing causality/process response time conditions) may be reflected in the intercooler freezing monitoring, and thus accuracy and/or reliability of intercooler freezing monitoring may be improved.

According to an aspect of the present disclosure, a device for monitoring freezing of an intercooler in a vehicle includes a controller configured to receive condition monitoring data including temperature data of a sensor unit of the vehicle including the intercooler. The controller is further configured to determine and change a degree of freezing progress of a plurality of freezing stages based on a process in which freezing progresses in the intercooler, according to the condition monitoring data. The controller is further configured to output the intercooler freezing monitoring data based on the degree of freezing progress.

In an example, a first freezing stage among the plurality of freezing stages may include a condensate generation stage in which condensate is generated in the intercooler or a lower freezing stage in which a lower portion of the intercooler is frozen. A second freezing stage among the plurality of freezing stages may include an outlet freezing stage in which an outlet of the intercooler is frozen or a boost pressure reduction stage in which intake pressure of the intercooler is reduced. The controller may be further configured to determine the degree of freezing progress based on a freezing stage of the intercooler among the plurality of freezing stages. The controller is further configured to selectively change the degree of freezing progress so as to change the freezing stage of the intercooler to a subsequent stage of the condensate generation stage or the lower freezing stage according to the condition monitoring data when the freezing stage of the intercooler corresponds to the first freezing stage. The controller is further configured to output the intercooler freezing monitoring data based on the condition monitoring data when the freezing stage of the intercooler corresponds to the second freezing stage.

In an example, the first freezing stage among the plurality of freezing stages may include the condensate generation stage. The controller may be further configured to selectively change the degree of freezing progress so as to change the freezing stage of the intercooler to a next stage of the condensate generation stage based on whether an accumulated driving time of the vehicle while the temperature data is within a set temperature range exceeds a first set time when the freezing stage of the intercooler corresponds to the condensate generation stage.

In an example, the temperature data may include outside temperature data corresponding to an external temperature of the intercooler and intercooler outlet temperature data corresponding to an outlet temperature of the intercooler. The set temperature range may be greater than 0 degrees Celsius, and the set temperature range is lower than a first set temperature in the outside temperature data, and lower than a second set temperature in the intercooler outlet temperature data.

In an example, a first freezing stage among the plurality of freezing stages may further include the lower freezing stage. When the freezing stage of the intercooler corresponds to the lower freezing stage, the controller may be further configured to selectively change the degree of freezing progress so as to change the freezing stage of the intercooler to a next stage of the lower freezing stage based on whether a time for which the vehicle is turned off while the temperature data is at a freezing-possible temperature exceeds a second set time.

In an example, the temperature data may include outside temperature data corresponding to an external temperature of the intercooler, the controller may further store outside temperature data at the time the vehicle is turned off and store outside temperature data at the time the vehicle is turned on. When the freezing stage of the intercooler corresponds to the lower freezing stage, the controller may be further configured to selectively change the degree of freezing progress so as to change the freezing stage of the intercooler to a next stage of the lower freezing stage, based on whether the outside temperature data at a time the vehicle is turned off is a freezing-possible temperature, the outside temperature data at a time the vehicle is turned on is a freezing-possible temperature, and a time the vehicle is turned off exceeds a second set time.

In an example, the second freezing stage among the plurality of freezing stages may include the outlet freezing stage and the boost pressure reduction stage. The temperature data may include intercooler outlet temperature data corresponding to an outlet temperature of the intercooler. The condition monitoring data may include boost pressure data corresponding to intake pressure of the intercooler. When the freezing stage of the intercooler corresponds to the outlet freezing stage, the controller may be further configured to selectively change the degree of freezing progress so as to change the freezing stage of the intercooler from the outlet freezing stage to the boost pressure reduction stage based on whether the outlet temperature of the intercooler is a freezing-possible temperature. When the freezing stage of the intercooler corresponds to the boost pressure reduction stage, the controller may be further configured to selectively output intercooler freezing monitoring data corresponding to an intercooler freezing warning, based on whether a boost pressure is lower than a set pressure.

In an example, the temperature data may include intercooler outlet temperature data corresponding to an outlet temperature of the intercooler. The condition monitoring data may include boost pressure data corresponding to the intake pressure of the intercooler. The controller may be further configured to output intercooler freezing monitoring data corresponding to an intercooler freezing warning based on whether the outlet temperature of the intercooler is a freezing-possible temperature and a boost pressure is lower than a set pressure, when the freezing stage of the intercooler corresponds to the second freezing stage.

In an example, the intercooler freezing monitoring logic may be further configured to selectively change the degree of freezing progress so as to control the freezing stage of the intercooler return to a previous stage of the outlet freezing stage or the boost pressure reduction stage based on whether the condition monitoring data satisfies a regression condition of a freezing progress degree, when the freezing stage of the intercooler corresponds to the second freezing stage.

In an example, the controller may be further configured to selectively change the degree of freezing progress so as to control the freezing stage of the intercooler return to a previous stage of the lower freezing stage, based on whether a number of times the vehicle is started on-off exceeds a set number of times when the freezing stage of the intercooler corresponds to the lower freezing stage.

In an example, the condition monitoring data may further include at least one of starting on-off data of the vehicle, driving time data of the vehicle, parking time data of the vehicle, or boost pressure data corresponding to intake pressure of the intercooler. The temperature data may include outside temperature data corresponding to an external temperature of the intercooler and intercooler outlet temperature data corresponding to an outlet temperature of the intercooler.

According to an aspect of the present disclosure, a vehicle includes the device for monitoring freezing of an intercooler in a vehicle. The vehicle further includes an engine combusting by mixing fuel with intake air. The vehicle further includes an intercooler disposed to cool the intake air. The vehicle further includes an intake line supplying the intake air to the engine. The vehicle further includes an exhaust line through which exhaust gas discharged from the engine flows. The vehicle further includes an EGR device having an EGR line branched from the exhaust line and joined to the intake line. The vehicle further includes an EGR cooler installed in the EGR line. The vehicle further includes a turbocharger compressing the intake air formed by joining a portion of the exhaust gas flowing through the EGR line and fresh air, while being rotated by the exhaust gas. The intercooler is disposed in the intake line and cools the intake air compressed by the turbocharger.

According to an aspect of the present disclosure, a method of monitoring freezing of an intercooler in a vehicle includes receiving condition monitoring data including temperature data of a sensor unit of the vehicle including the intercooler. The method further includes determining and changing a degree of freezing progress of a plurality of freezing stages based on a process in which freezing progresses in the intercooler according to the condition monitoring data. The method further includes outputting intercooler freezing monitoring data based on the degree of freezing progress.

In an example, a first freezing stage among the plurality of freezing stages may include a condensate generation stage in which condensate is generated in the intercooler or a lower freezing stage in which a lower portion of the intercooler is frozen. A second freezing stage among the plurality of freezing stages may include an outlet freezing stage in which an outlet of the intercooler is frozen or a boost pressure reduction stage in which an intake pressure of the intercooler is reduced. The method may further include determining the degree of freezing progress based on a freezing stage of the intercooler among the plurality of freezing stages. The method may further include selectively changing the degree of freezing progress so as to change the freezing stage of the intercooler to a next stage of the condensate generation stage or the lower freezing stage according to the condition monitoring data, when the freezing stage of the intercooler corresponds to the first freezing stage. The method may further include outputting the intercooler freezing monitoring data based on the condition monitoring data when the freezing stage of the intercooler corresponds to the second freezing stage.

In an example, the first freezing stage among the plurality of freezing stages may include the condensate generation stage. The method may further include selectively changing the degree of freezing progress so as to change the freezing stage of the intercooler to a next stage of the condensate generation stage based on whether an accumulated driving time of the vehicle while the temperature data is within a set temperature range exceeds a first set time, when the freezing stage of the intercooler corresponds to the condensate generation stage.

In an example, the first freezing stage among the plurality of freezing stages may include the lower freezing stage. The method may further include selectively changing the degree of freezing progress so as to change the freezing stage of the intercooler to a next stage of the lower freezing stage based on whether a time that the vehicle is turned off while the temperature data is a freezing-possible temperature exceeds a second set time, when the freezing stage of the intercooler corresponds to the lower freezing stage.

In an example, the temperature data may include intercooler outlet temperature data corresponding to an outlet temperature of the intercooler. The condition monitoring data may include boost pressure data corresponding to an intake pressure of the intercooler. The method may further include outputting intercooler freezing monitoring data corresponding to an intercooler freezing warning based on whether an intercooler outlet temperature is a freezing-possible temperature and a boost pressure is lower than a set pressure, when the freezing stage of the intercooler corresponds to the second freezing stage.

In an example, the method may further include selectively changing the degree of freezing progress so as to control the freezing stage of the intercooler returns to a previous stage based on whether the condition monitoring data satisfies a regression condition of freezing progress degree.

According to an aspect of the present disclosure, a storage medium includes at least one program recorded thereon. The at least one program includes instructions for executing the method of monitoring freezing of an intercooler in a vehicle.

### BRIEF DESCRIPTION OF DRAWINGS

The above and other aspects, features, and advantages of the present disclosure should be more clearly understood from the following detailed description, taken in conjunction with the accompanying drawings, in which:

FIG. 1 is a drawing illustrating a device for monitoring freezing of an intercooler in a vehicle and a vehicle and a storage medium according to an embodiment;

FIG. 2 is a drawing illustrating a device and a method for monitoring freezing of an intercooler in a vehicle, and a vehicle and a storage medium, monitoring the intercooler according to an embodiment;

FIG. 3 is a drawing illustrating a degree of freezing progress of an intercooler monitored by a device and a method for monitoring freezing of an intercooler in a vehicle, and a vehicle and a storage medium, according to an embodiment;

FIG. 4 is a flowchart illustrating a method of monitoring freezing of an intercooler in a vehicle according to an embodiment;

FIG. 5 is a flowchart illustrating a degree of freezing progress of an intercooler determined by a device and method for monitoring freezing of an intercooler in a vehicle, and a vehicle and a storage medium, according to an embodiment; and

FIG. 6 and FIG. 7 are flowcharts illustrating the flowchart of FIG. 5 in more detail.

### DETAILED DESCRIPTION

The present disclosure may have various modifications and may have various embodiments, and thus specific embodiments are illustrated in the drawings and described in detail. However, this is not intended to limit the present disclosure to specific embodiments but should be understood to include all modifications, equivalents, and substitutes included in the spirit and technical scope of the present disclosure.

The terms first, second, etc. may be used to describe various components, but the components should not be limited by the terms. The terms are used only for the purpose of distinguishing one component from another. For example, without departing from the scope of the present disclosure, the first component may be referred to as the second component, and similarly, the second component may also be referred to as the first component. The term ‘and/or’ includes a combination of a plurality of related described items or any of a plurality of related described items.

The terms used in the present disclosure are used only to describe detailed embodiments and are not intended to limit the present disclosure. The singular expression includes the plural expression unless the context clearly indicates otherwise. In the present disclosure, the terms “include,” “have,” or the like are intended to specify the presence of a feature, number, operation, stage, component, part, or combination thereof described in the present disclosure and should be understood as not excluding in advance the possibility of the presence or addition of one or more other features, numbers, operations, stages, components, parts, or combinations thereof. When a controller, module, component, device, element, or the like of the present disclosure is described as having a purpose or performing an operation, function, or the like, the controller, module, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus.

Unless otherwise defined, all terms used herein, including technical or scientific terms, have the same meaning as commonly understood by a person of ordinary skill in the art to which the present disclosure belongs. Terms commonly used and defined in dictionaries should be interpreted as having a meaning consistent with the meaning they have in the context of the relevant technology. The terms shall not be interpreted in an ideal or excessively formal sense unless explicitly defined in this application.

In the present disclosure, a vehicle (including an electric vehicle) means various vehicles that move a transported object such as a person, an animal, or an object from a starting point to a destination. Such vehicles are not limited to vehicles that run on roads or tracks.

Hereinafter, example embodiments of the present disclosure are described in more detail with reference to the attached drawings.

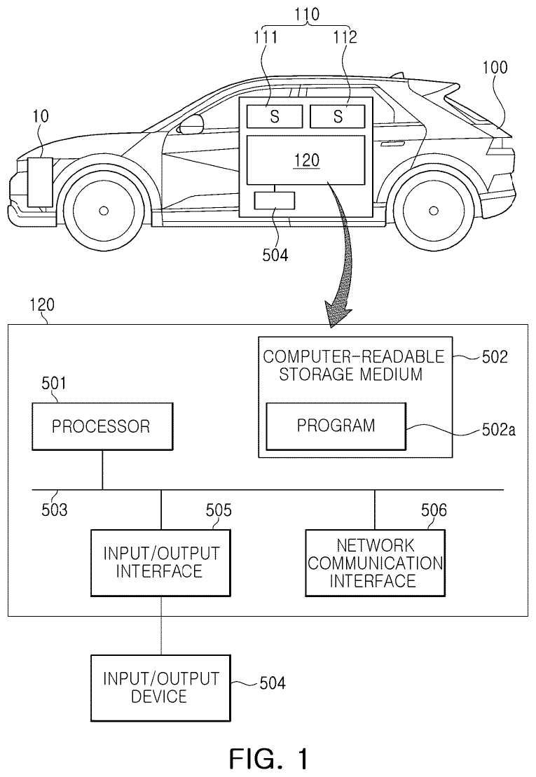

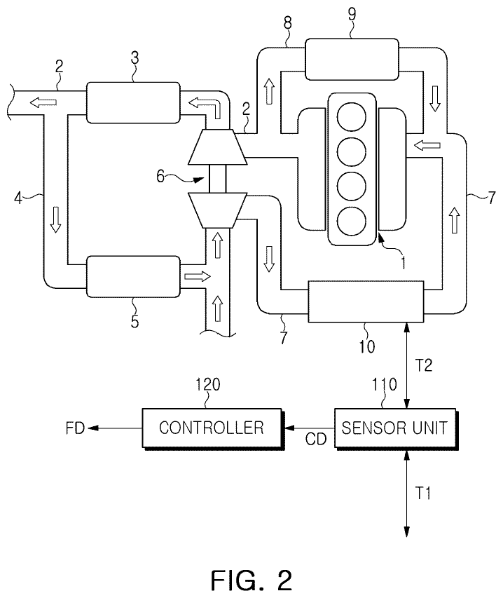

Referring to FIG. 1, a vehicle 100 may include an intercooler 10. Referring to FIG. 2, an engine system of the vehicle 100 may include at least one of the intercooler 10, an engine 1, an exhaust line 2, a diesel particulate filter 3 (hereinafter, referred to as a “DPF”), an exhaust gas recirculation (EGR) line 4, an EGR cooler 5, a turbocharger 6, an intake line 7, a high-pressure EGR line 8, or a high-pressure EGR cooler 9. The EGR line 4 and the EGR cooler 5 may constitute an EGR device, and the high-pressure EGR line 8 and the high-pressure EGR cooler 9 may constitute a high-pressure EGR device.

For example, the intercooler 10 may be applied to an engine system of a diesel vehicle, but is not necessarily limited thereto. Based on the design, the intercooler 10 may be applied to an engine system of a gasoline vehicle, and the EGR device may be further simplified or smaller.

This engine system may recirculate a portion of the exhaust gas discharged through the exhaust line 2 from the exhaust manifold of the engine 1 to the intake line 7. In this case, the intercooler 10 may be disposed in the EGR device that recirculates the exhaust gas at the rear end of the DPF 3 to the intake line 7.

In the EGR device, a portion (low-pressure EGR gas) of the exhaust gas, having passed through the DPF 3, and the fresh air are combined to form ‘intake’ and may be compressed through the turbocharger 6 and supplied to the intake manifold of the engine 1.

The intake air is compressed by the turbocharger 6, and thus the temperature increases and expands, which causes the oxygen density to decrease. To improve this, the intercooler 10 may be installed on the intake line 7 at the rear end of the turbocharger, to cool the intake to a set temperature.

The intercooler 10 may cool (heat exchange) the intake air supplied from the turbocharger 6 through the intake line 7 and then may supply the cooled intake air to the intake manifold of the engine 1.

In this way, by using the intercooler 10, the high temperature intake air compressed through the turbocharger 6 is cooled to increase the oxygen density, and the intake efficiency of the intake air flowing into the combustion chamber of the engine 1 through the intake manifold is increased, thereby improving the combustion efficiency of the engine.

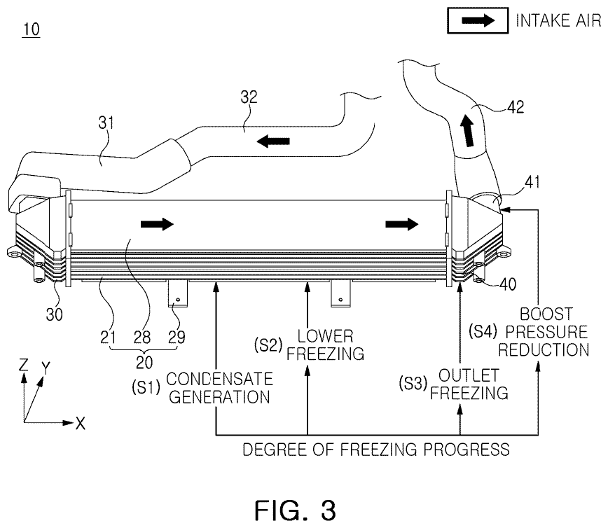

Referring to FIGS. 2 and 3, the intercooler 10 may include a core 20, an intercooler inlet 30, intake inlet lines 31 and 32, an intercooler outlet 40, and intake outlet lines 41 and 42.

The intake inlet lines 31 and 32 and the intake outlet lines 41 and 42 may be connected to the intake line 7 of FIG. 2 or may be at least a portion of the intake line 7 of FIG. 2. Alternatively, a portion of the intake inlet line 32 and a portion of the intake outlet line 42 may be at least a portion of the intake line 7 of FIG. 2 and may be connected to the remaining intake inlet line 31 and the remaining intake outlet line 41. The intake inlet lines 31 and 32 may be connected to the intercooler inlet 30 having an internal space and may provide a path for the intake to flow. The intake outlet lines 41 and 42 may be connected to the intercooler outlet 40 having an internal space and may provide a path for the intake to flow.

For example, the intercooler inlet 30 may have a form in which the cross-sectional area (the area of the cross-section formed in the Y-direction and the Z-direction) gradually increases from the intake inlet lines 31 and 32 to the core 20 (the form open in the +X direction), and the intercooler outlet 40 may have a form in which the cross-sectional area gradually decreases from the core 20 to the intake outlet lines 41 and 42 (the form open in the X-direction), but the present disclosure is not limited thereto.

The core 20 of the intercooler 10 may have a tube stack structure in which a plurality of tubes 21 are arranged in the height direction (for example, in the Z-direction). A housing 28 may protect the core 20 (for example, protect against external impact) by covering the upper and lower surfaces of the core 20. The housing 28 may have a bracket 29 and may be coupled to a specific location of the vehicle through the bracket 29.

Each of the plurality of tubes 21 may have a cooling fin structure and may be configured to allow the intake air to flow therein and discharge therefrom. The cooling fin structure may form cooling passages within the plurality of tubes 21. The intake air flowing within the plurality of tubes 21 may be cooled by impinging (for example, jet impingement) on the inner surfaces of the plurality of tubes 21, and the cooling fin structure may provide an additional surface (or an additional flow path for the intake air) on which the intake air flowing within the plurality of tubes 21 impinges, thereby allowing the intake air to be cooled more efficiently. For example, the cooling fin structure and/or the plurality of tubes 21 may be made of a material having high thermal conductivity (for example, aluminum) and may absorb the heat of the intake air and dissipate the heat to the outside of the core 20, and the dissipated heat may be cooled by the wind outside the vehicle as the vehicle is driven.

A device for monitoring freezing of an intercooler in a vehicle according to an embodiment may include a controller 120 configured to receive condition monitoring data (CD) including temperature data T1 or T2 of a sensor unit 110 of a vehicle 100. The controller 120 is further configured to output intercooler freezing monitoring data (FD) provided by applying the condition monitoring data (CD) to intercooler freezing monitoring logic. For example, the controller 120 may be implemented as an Electronic Control Unit (ECU), but is not limited thereto.

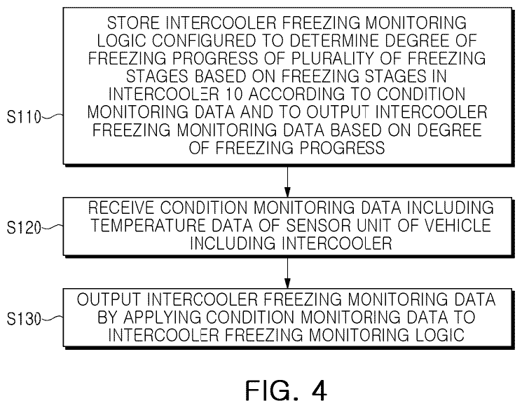

Referring to FIGS. 2, 3, and 4, a method of monitoring freezing of an intercooler in a vehicle according to an embodiment may include an operation (S110) of storing intercooler freezing monitoring logic. The method may further include an operation (S120) of receiving condition monitoring data including temperature data. The method may further include an operation (S130) of outputting intercooler freezing monitoring data by applying the condition monitoring data to the intercooler freezing monitoring logic. The controller 120 (see FIG. 2) may execute the method of monitoring freezing of an intercooler in a vehicle.

The sensor unit 110 may include a temperature sensor 111 providing temperature data T1 or T2 to the controller 120 and may further include a boost pressure sensor 112 providing boost pressure data corresponding to the intake pressure of the intercooler 10 to the controller 120. The temperature data T1 or T2 may include outside temperature data T1 corresponding to the outside temperature of the intercooler 10 and may include intercooler outlet temperature data T2 corresponding to the outlet temperature of the intercooler 10.

For example, the temperature sensor 111 may monitor (continuously sense) the temperature of the outside of the vehicle 100 (or a portion of the vehicle far from the intercooler within the vehicle) to periodically generate outside temperature data T1. The temperature sensor 111 may provide the outside temperature data T1 to the controller 120. For example, the temperature sensor 111 may monitor (continuously sense) the temperature of the intercooler outlet 40 to periodically generate intercooler outlet temperature data T2 and provide the intercooler outlet temperature data T2 to the controller 120. For example, the boost pressure sensor 112 may monitor (continuously sense) the boost pressure of the intake outlet lines 41 and 42 to periodically generate boost pressure data and provide the boost pressure data to the controller 120.

For example, in addition to the temperature data T1 or T2, the condition monitoring data (CD) may further include at least one of the starting on-off data of the vehicle 100, the driving time data of the vehicle 100, the parking time data of the vehicle 100, or the boost pressure data. For example, the starting on-off data may include the data on the time when the vehicle's engine is turned off, the data on the time when the vehicle's engine is turned on, and the data on the number of times the vehicle's engine is turned on and off. For example, driving time data may include time difference data from the time the vehicle's engine is turned on to the time the vehicle's engine is turned off. For example, parking time data may include time difference data from the time the vehicle's engine is turned off to the time the vehicle's engine is turned on.

In an environment with low ambient temperature, such as during winter, or high humidity, such as during a rainy season, moisture (for example, condensate) inside the intercooler 10 may freeze, and the ice inside the intercooler 10 may gradually grow, and the grown ice may block the flow of intake air of the intercooler 10. If the flow of intake air of the intercooler 10 is not smooth, the boost pressure of the intake air may decrease. The intake air with reduced boost pressure may damage the engine 1 or may reduce the performance and/or efficiency of the engine 1.

In this way, the process of freezing in the intercooler 10 may proceed sequentially. The intercooler freezing monitoring logic may be configured to determine the degree of freezing progress of a plurality of freezing stages based on the process in which freezing progresses in the intercooler 10, according to condition monitoring data (CD. The intercooler freezing monitoring logic may be configured to output intercooler freezing monitoring data (FD) based on the degree of freezing progress. Accordingly, the controller 120 may reflect the process (for example, freezing causality/process response time conditions) in which freezing progresses in the intercooler 10, in the intercooler freezing monitoring, thereby improving the accuracy and/or reliability of the intercooler freezing monitoring.

The intercooler freezing monitoring logic may be configured to determine the degree of freezing progress based on which stage of the plurality of freezing stages the freezing stage of the intercooler 10 corresponds to. For example, the controller 120 may initially select the degree of freezing progress 1, may selectively change the degree of freezing progress 1 to the degree of freezing progress 2 based on whether the freezing stage of the intercooler 10 is in progress, and may selectively change the degree of freezing progress 2 to the degree of freezing progress 1 based on whether the degree of freezing progress of the intercooler 10 returns.

For example, the degree of freezing progress 1 may include the degree of freezing progress 1-1 and/or the degree of freezing progress 1-2, and the degree of freezing progress 2 may include the degree of freezing progress 2-1 and/or the degree of freezing progress 2-2. The controller 120 may determine the degree of freezing progress in the order of degree of freezing progress 1-1, degree of freezing progress 1-2, degree of freezing progress 2-1, and degree of freezing progress 2-2 according to the freezing progresses of the intercooler 10. The number of degrees of freezing progress is not limited to 2 to 4.

Among the plurality of freezing stages, the first freezing stage (degree of freezing progress 1) may include a condensate generation stage (S1) (degree of freezing progress 1-1) in which condensate is generated in the intercooler 10 and/or a lower freezing stage (S2) (degree of freezing progress 1-2) in which a lower portion of the intercooler 10 is frozen. The concept of the freezing stage (condensate generation, lower freezing) is not limited thereto.

In condensate generation stage (S1), the temperature of the intake air flowing into the intercooler 10 may be relatively high compared to the temperature inside the intercooler 10, due to the use of the EGR line 4 and/or the EGR cooler 5. If the external temperature is not high, the temperature difference between the inside of the intercooler 10 and the intake air may gradually generate condensate inside the intercooler 10. If the condensate is sufficiently generated, the controller 120 may change the degree of freezing progress from the condensate generation stage (S1) (degree of freezing progress 1-1) to the lower freezing stage (S2) (degree of freezing progress 1-2) or to the second freezing stage (degree of freezing progress 2).

In the lower freezing stage (S2), as the outside temperature decreases, the accumulated condensate may gradually freeze. If the accumulated condensate is sufficiently frozen, the controller 120 may change the degree of freezing progress from the lower freezing stage (S2) (degree of freezing progress 1-2) to the outlet freezing stage (S3) (degree of freezing progress 2-1) or may output intercooler freezing monitoring data (FD) corresponding to a weak warning message indicating a high possibility of freezing of the intercooler outlet 40.

Among the plurality of freezing stages, the second freezing stage (degree of freezing progress 2) may include an outlet freezing stage (S3) (degree of freezing progress 2-1) in which the intercooler outlet 40 freezes and/or a boost pressure reduction stage (S4) (degree of freezing progress 2-2) in which the intake pressure of the intercooler 10 is reduced. The concept of the freezing stage (outlet freezing, boost pressure reduction) is not limited thereto.

In outlet freezing stage (S3), when the temperature of the intercooler outlet 40 is low, condensate freezing may gradually grow toward the intercooler outlet 40 along with the moisture of the intercooler outlet 40. The growth may be further accelerated as the humidity of the intercooler outlet 40 is high. When the freezing of the intercooler outlet 40 has grown sufficiently, the controller 120 may change the degree of freezing progress from outlet freezing stage (S3) (degree of freezing progress 2-1) to boost pressure reduction stage (S4) (degree of freezing progress 2-2) or may output intercooler freezing monitoring data (FD) corresponding to an intermediate warning message indicating that the freezing of the intercooler outlet 40 is growing.

In the boost pressure reduction stage (S4), the growth of freezing in the intercooler outlet 40 may significantly reduce the intake flow of the intercooler outlet 40 (for example, reduce the cross-sectional area of the intercooler outlet) and may gradually reduce the boost pressure of the intake air. When the boost pressure is effectively reduced, the controller 120 may output intercooler freezing monitoring data (FD) corresponding to a strong warning message indicating that freezing in the outlet of the intercooler 10 is serious.

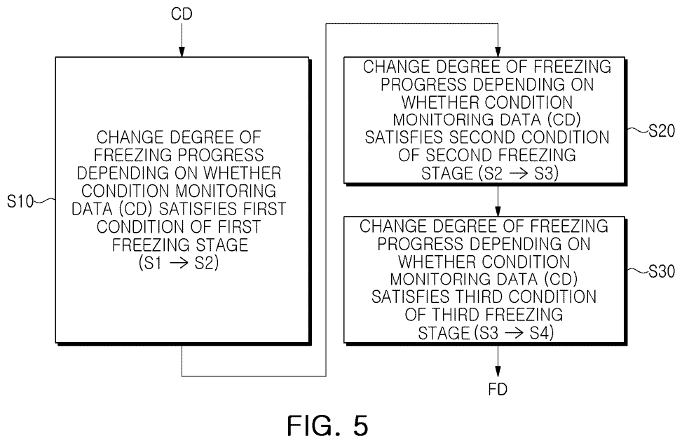

Referring to FIGS. 3 and 5, the intercooler freezing monitoring logic may be configured to selectively change (S10 or S20) the degree of freezing progress so that the freezing stage of the intercooler 10 moves to the next stage (for example, lower freezing stage (S2), outlet freezing stage (S3), or boost pressure reduction stage (S4)) of the condensate generation stage (S1) or lower freezing stage (S2), according to condition monitoring data (CD), when the freezing stage of the intercooler 10 corresponds to the condensation generation stage (S1) or the lower freezing stage (S2).

The intercooler freezing monitoring logic may selectively determine (S30, first Yes) the degree of freezing progress so that the freezing stage of the intercooler 10 moves from the outlet freezing stage (S3) to the boost pressure reduction stage (S4) based on condition monitoring data (CD), when the freezing stage of the intercooler 10 corresponds to the outlet freezing stage (S3). Alternatively, the intercooler freezing monitoring logic may be configured to output (second Yes in S30) intercooler freezing monitoring data (FD) based on condition monitoring data (CD), when the freezing stage of the intercooler 10 corresponds to an outlet freezing stage (S3) or a boost pressure reduction stage (S4). For example, the controller 120 may output intercooler freezing monitoring data (FD) corresponding to one selected from the weak warning message, the intermediate warning message, or the strong warning message, but is not limited thereto.

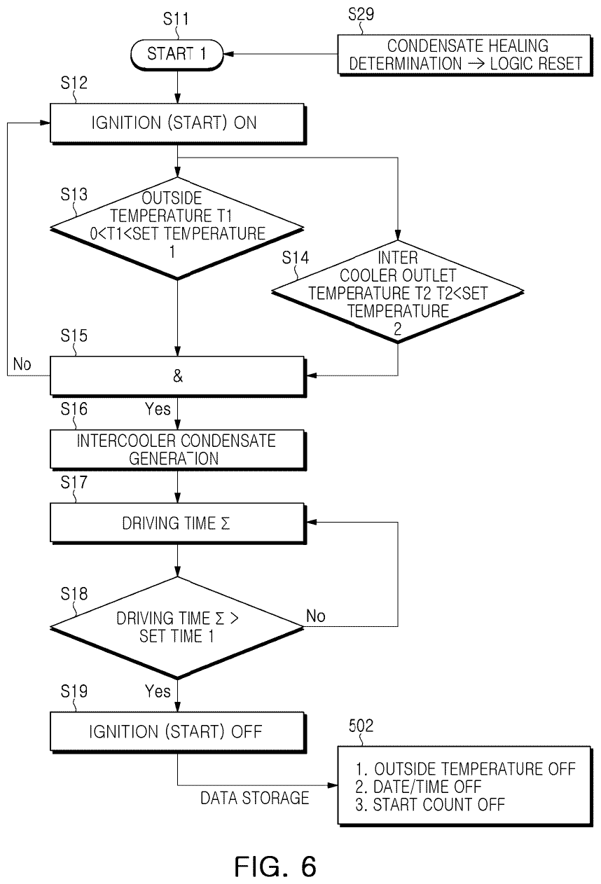

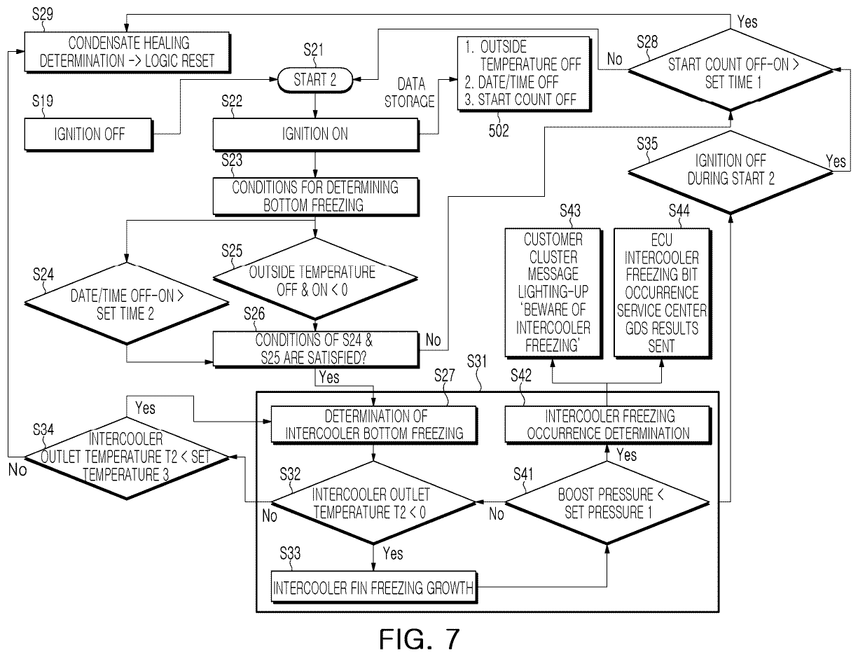

Referring to FIG. 6, if the freezing stage of the intercooler corresponds (S11 to S19) to the condensate generation stage (S1 in FIG. 3), the intercooler freezing monitoring logic may be configured to selectively (S18) determine the degree of freezing progress so that the freezing stage of the intercooler proceeds to the next stage (S21 of FIG. 7) of the condensate generation stage (S11 to S19), based on whether the accumulated driving time (S17) of the vehicle (between ignition-on (S12) and ignition-off (S19)) in the intercooler condensate generation (S16) exceeds the first set time (set time 1) while the temperature data T1 and/or T2 is within the set temperature range (by Yes in S13, S14, and S15).

The temperature data includes outside temperature data T1 corresponding to the outside temperature of the intercooler and intercooler outlet temperature data T2 corresponding to the intercooler outlet temperature, and the set temperature range may indicate that the outside temperature data T1 is greater than 0 degrees Celsius and lower than the first set temperature (set temperature 1) (corresponding to S13) and the intercooler outlet temperature data T2 is lower than the second set temperature (set temperature 2) (corresponding to S14).

For example, the outside temperature data T1 being greater than 0 degrees Celsius may correspond to the usage conditions of the EGR line 4 (see FIG. 2) and/or the EGR cooler 5 (see FIG. 2), and the outside temperature data T1 being lower than the first set temperature (set temperature 1) may correspond to the condition for generating condensate due to the temperature difference between the surface temperature of the fin of the intercooler and the temperature of the intake air. For example, the intercooler outlet temperature data T2 being lower than the second set temperature (set temperature 2) may correspond to a condition in which the intake air is sufficiently cooled by the intercooler and condensation occurs by the saturated vapor curve.

When the freezing stage of the intercooler moves to the next stage (S21 of FIG. 7) of the condensate generation stage (corresponding to S11 to S19), the controller may non-volatilely store the outside temperature data T1, the date/time data, and start count data at the time the vehicle's engine is turned off (at time point S19).

Referring to FIG. 7, when the freezing stage of the intercooler corresponds (corresponding to S21 to S29) to the lower freezing stage (S2 in FIG. 3), the intercooler freezing monitoring logic may be configured to determine the degree of freezing progress so that the freezing stage of the intercooler moves to the next stage (S31) of the lower freezing stage (S21 to S29), as selective (by Yes in S24 and S26) intercooler bottom freezing determination (S27), based on whether the vehicle engine-off time exceeds the second set time (set time 2) while the temperature data (for example, outside temperature data T1) is a freezing-possible temperature (for example, a temperature lower than 0 degrees Celsius) (Yes in S23 and S25).

The controller may non-volatilely store outside temperature data T1, date/time data, and start count data at the time the vehicle's engine is started (time point S22). When the freezing stage of the intercooler corresponds (corresponding to S21 to S29) to the lower freezing stage (S2 in FIG. 3), the intercooler freezing monitoring logic may be configured to determine the degree of freezing progress so that the freezing stage of the intercooler moves to the next stage (S31) of the lower freezing stage (S21 to S29), as selective (by Yes in S24, S25, and S26) intercooler bottom freezing determination (S27), based on whether the outside temperature data T1 at the time when the vehicle's engine is turned off (at time point S19) is a freezing-possible temperature (for example, a temperature lower than 0 degrees Celsius) and the outside temperature data T1 at the time when the vehicle's engine is turned on (at time point S22) is a freezing-possible temperature (for example, a temperature lower than 0 degrees Celsius) and based on whether the time when the vehicle's engine is turned off (the time difference between the time point S19 and the time point S22) exceeds the second set time (set time 2).

For example, if the outside temperature data T1 at the time the vehicle is turned off (time point S19) and the time the vehicle is turned on (time point S22) are both freezing-possible temperatures (for example, temperatures lower than 0 degrees Celsius), the controller may infer that the outside temperature data T1 has maintained the freezing-possible temperature (for example, a temperature lower than 0 degrees Celsius) throughout the parking time of the vehicle. For example, in the controller, the second set time (set time 2) may be set to a sufficient time condition for the condensate to freeze.

The intercooler freezing monitoring logic may be configured to selectively (Yes in S28) determine the degree of freezing progress so that the freezing stage of the intercooler returns to the previous stage (S11 to S19 of FIG. 6) of the lower freezing stage (S21 to S29) based on whether the number of times the vehicle's engine is turned on-off exceeds the set number of times (set number 1), when the freezing stage of the intercooler corresponds (S21 to S29) to the lower freezing stage (S2 of FIG. 3).

For example, based on the start-up of the vehicle, the engine 1 may slightly heal the intercooler freezing while introducing intake air. As the number of times the vehicle's engine is turned on-off increases, the accumulation of the healing may gradually increase. As the accumulation of the healing exceeds the set number of times (set number 1), the freezing stage of the intercooler may return to the previous stage.

The intercooler freezing monitoring logic may be configured to selectively (as intercooler fin freezing growth (S33) by Yes in S32) determine the degree of freezing progress so that the freezing stage of the intercooler moves from the outlet freezing stage (S32 to S35) to the boost pressure reduction stage (S41 to S44), based on whether the intercooler outlet temperature T2 is a freezing-possible temperature (for example, a temperature lower than 0 degrees Celsius), when the freezing stage of the intercooler corresponds (S32 to S35) to the outlet freezing stage (S3 in FIG. 3).

The intercooler freezing monitoring logic may be configured to selectively (Yes in S41) output the intercooler freezing monitoring data corresponding to the intercooler freezing warning (S43 or S44) based on whether the boost pressure is lower than the set pressure (set pressure 1), when the freezing stage of the intercooler corresponds (S41 to S44) to the boost pressure reduction stage (S4 in FIG. 3). For example, the intercooler freezing warning (S43 or S44) may be one selected from the weak warning message, the intermediate warning message, or the strong warning message, but is not limited thereto.

The intercooler freezing monitoring logic may be configured to output intercooler freezing monitoring data corresponding to the intercooler freezing warning (S43 or S44) based on whether the intercooler outlet temperature T2 is a freezing-possible temperature (for example, a temperature lower than 0 degrees Celsius) and the boost pressure is lower than the set pressure (set pressure 1) (Yes in S32 and Yes in S41), when the freezing stage of the intercooler corresponds (S31) to the outlet freezing stage (S3 in FIG. 3) or the boost pressure reduction stage (S4 in FIG. 3).

For example, a minimum freezing condition for the freezing of the intercooler outlet to effectively reduce the boost pressure may vary based on the location or shape of the fin, or the like. Therefore, the set pressure (set pressure 1) may be appropriately set according to the position or shape of the fin.

The intercooler freezing monitoring logic may be configured to selectively determine the degree of freezing progress so that the freezing stage of the intercooler returns (S29) to the previous stage (S11 to S19 of FIG. 6 or S21 to S29 of FIG. 7) of the outlet freezing stage or the boost pressure reduction stage, based on whether the condition monitoring data satisfies the regression condition of freezing progress degree (S34 or S35), when the freezing stage of the intercooler corresponds (S31) to the outlet freezing stage (S3 of FIG. 3) or the boost pressure reduction stage (S4 of FIG. 3).

The regression condition of freezing progress degree (S34 or S35) may include, but is not limited to, a condition (S28 and/or S35) in which the number of vehicle ignition on-off cycles exceeds a set number (S28), and a condition (S34) in which the intercooler outlet temperature T2 is lower than a third set temperature (set temperature 3).

Referring to FIG. 1, the controller 120 of a device for monitoring freezing of an intercooler in a vehicle according to an embodiment may be implemented as a computing system including at least one processor 501, a computer-readable storage medium 502, and a communication bus 503. For example, the controller 120 may be implemented as a microcontroller or an embedded system. The storage medium 502 may record one or more programs including instructions for executing the method of monitoring freezing of an intercooler in a vehicle according to an embodiment. The communication bus 503 may include the processor 501 and the computer-readable storage medium 502 and interconnect other various components of the computing device.

The processor 501 may cause the controller 120 to operate according to the example embodiment mentioned above. For example, the processor 501 may execute one or more programs stored in the computer-readable storage medium 502. The one or more programs may include one or more computer-executable instructions, and when the computer-executable instruction is executed by the processor 501, the processor may be configured to enable the controller 120 to perform stages according to an example embodiment.

The computer-readable storage medium 502 may be configured to store computer-executable instructions, program code, program data, and/or other suitable forms of information. The program 502a stored on the computer-readable storage medium 502 includes a set of instructions executable by the processor 501. In an embodiment, the computer-readable storage medium 502 may be memory (volatile memory, such as random access memory, nonvolatile memory, or a suitable combination thereof), one or more magnetic disk storage devices, optical disk storage devices, flash memory devices, or other forms of storage media that are accessible by the controller 120 and capable of storing required information, or suitable combinations thereof.

The controller 120 may also include one or more input/output interfaces 505 providing interfaces for one or more input/output devices 504 and one or more network communication interfaces 506. The input/output interface 505 and the network communication interface 506 are connected to a communication bus 503. The network may be any one of a cellular network, such as Global System for Mobile Communications (GSM), Enhanced Data Rates for GSM Evolution (EDGE), General Packet Radio Service (GPRS), Code Division Multiple Access (CDMA), Time Division-CDMA (TD-CDMA), Universal Mobile Telecommunications System (UMTS), Long Term Evolution (LTE), 5G, Wi-Fi, or another cellular network, and may also be implemented as Ethernet, Media Oriented Systems Transport (MOST), Flexray, Controller Area Network (CAN), Local Interconnect Network (LIN), Internet, Bluetooth, Near Field Communication (NFC), Zigbee, Radio Frequency (RF), or the like.

The input/output device 504 may be connected to other components of the controller 120 via the input/output interface 505. The example input/output devices 504 may include input devices such as pointing devices (such as a mouse or trackpad), keyboards, touch input devices (such as a touchpad or a touchscreen), voice or sound input devices, various types of sensor devices and/or photographing devices, and/or output devices such as display devices, printers, speakers, and/or network cards. The example input/output devices 504 may be included within the controller 120, as a component constituting the controller 120, or may be connected to the controller 120, as a separate device distinct from the controller 120.

In an embodiment of the present disclosure, a program for executing the methods described herein on a computer, and a computer-readable recording medium including the program, may be included. The computer-readable recording medium may include program instructions, local data files, local data structures, and the like, alone or in combination. The medium may be specially designed and configured for the present disclosure or may be commonly available in the field of computer software. Examples of computer-readable recording media include magnetic media such as hard disks, floppy disks, and magnetic tapes, optical recording media such as CD-ROMs and DVDs, and hardware devices specifically configured to store and execute program instructions, such as ROMs, RAMs, and flash memories. Examples of such programs may include not only machine language codes such as those generated by a compiler, but also high-level language codes that may be executed by a computer using an interpreter or the like.

As set forth above, a device and method for monitoring freezing of an intercooler in a vehicle and a vehicle and storage medium including the same according to an embodiment may reflect the process of freezing in an intercooler (for example, freezing causality/process response time conditions) to intercooler freezing monitoring, thereby improving the accuracy and/or reliability of intercooler freezing monitoring.

While example embodiments have been shown and described above, it should be apparent to those having ordinary skill in the art that modifications and variations could be made without departing from the scope of the present disclosure as defined by the appended claims.

What is claimed is:

1. A device for monitoring freezing of an intercooler in a vehicle, the device comprising:
a controller configured to:
receive condition monitoring data including temperature data of a sensor unit of the vehicle including the intercooler;
determine and change a degree of freezing progress of a plurality of freezing stages based on a process in which freezing progresses in the intercooler, according to the condition monitoring data; and
output the intercooler freezing monitoring data based on the degree of freezing progress.

2. The device of claim 1, wherein a first freezing stage among the plurality of freezing stages includes a condensate generation stage in which condensate is generated in the intercooler or a lower freezing stage in which a lower portion of the intercooler is frozen,
wherein a second freezing stage among the plurality of freezing stages includes an outlet freezing stage in which an outlet of the intercooler is frozen or a boost pressure reduction stage in which intake pressure of the intercooler is reduced, and
wherein the controller is further configured to:
determine the degree of freezing progress based on a freezing stage of the intercooler among the plurality of freezing stages;
selectively change the degree of freezing progress so as to change the freezing stage of the intercooler to a subsequent stage of the condensate generation stage or the lower freezing stage according to the condition monitoring data when the freezing stage of the intercooler corresponds to the first freezing stage; and
output the intercooler freezing monitoring data based on the condition monitoring data when the freezing stage of the intercooler corresponds to the second freezing stage.

3. The device of claim 2, wherein the first freezing stage among the plurality of freezing stages includes the condensate generation stage, and
wherein the controller is further configured to selectively change the degree of freezing progress so as to change the freezing stage of the intercooler to a next stage of the condensate generation stage based on whether an accumulated driving time of the vehicle while the temperature data is within a set temperature range exceeds a first set time when the freezing stage of the intercooler corresponds to the condensate generation stage.

4. The device of claim 3, wherein the temperature data includes outside temperature data corresponding to an external temperature of the intercooler and intercooler outlet temperature data corresponding to an outlet temperature of the intercooler, and
wherein the set temperature range is greater than 0 degrees Celsius and lower than a first set temperature in the outside temperature data, and the set temperature range is lower than a second set temperature in the intercooler outlet temperature data.

5. The device of claim 3, wherein a first freezing stage among the plurality of freezing stages further includes the lower freezing stage, and
wherein when the freezing stage of the intercooler corresponds to the lower freezing stage, the controller is further configured to selectively change the degree of freezing progress so as to change the freezing stage of the intercooler to a next stage of the lower freezing stage based on whether a time for which the vehicle is turned off while the temperature data is at a freezing-possible temperature exceeds a second set time.

6. The device of claim 5, wherein the temperature data includes outside temperature data corresponding to an external temperature of the intercooler,
wherein the controller is further configured to:
store outside temperature data at the time the vehicle is turned off; and
store outside temperature data at the time the vehicle is turned on, and
wherein when the freezing stage of the intercooler corresponds to the lower freezing stage, the controller is further configured to selectively change the degree of freezing progress so as to change the freezing stage of the intercooler to a next stage of the lower freezing stage, based on whether the outside temperature data at a time the vehicle is turned off is a freezing-possible temperature, the outside temperature data at a time the vehicle is turned on is a freezing-possible temperature, and a time the vehicle is turned off exceeds a second set time.

7. The device of claim 5, wherein the second freezing stage among the plurality of freezing stages includes the outlet freezing stage and the boost pressure reduction stage,
wherein the temperature data includes intercooler outlet temperature data corresponding to an outlet temperature of the intercooler,
wherein the condition monitoring data includes boost pressure data corresponding to intake pressure of the intercooler, and
wherein the controller is further configured to:
when the freezing stage of the intercooler corresponds to the outlet freezing stage, selectively change the degree of freezing progress so as to change the freezing stage of the intercooler from the outlet freezing stage to the boost pressure reduction stage based on whether the outlet temperature of the intercooler is a freezing-possible temperature, and
when the freezing stage of the intercooler corresponds to the boost pressure reduction stage, selectively output intercooler freezing monitoring data corresponding to an intercooler freezing warning, based on whether a boost pressure is lower than a set pressure.

8. The device of claim 2, wherein the temperature data includes intercooler outlet temperature data corresponding to an outlet temperature of the intercooler,
wherein the condition monitoring data includes boost pressure data corresponding to the intake pressure of the intercooler, and
wherein the controller is further configured to output intercooler freezing monitoring data corresponding to an intercooler freezing warning based on whether the outlet temperature of the intercooler is a freezing-possible temperature and a boost pressure is lower than a set pressure, when the freezing stage of the intercooler corresponds to the second freezing stage.

9. The device of claim 8, wherein the controller is further configured to selectively change the degree of freezing progress so as to control the freezing stage of the intercooler to return to a previous stage of the outlet freezing stage or the boost pressure reduction stage based on whether the condition monitoring data satisfies a regression condition of a freezing progress degree, when the freezing stage of the intercooler corresponds to the second freezing stage.

10. The device of claim 5, wherein the controller is further configured to selectively change the degree of freezing progress so as to control the freezing stage of the intercooler return to a previous stage of the lower freezing stage, based on whether a number of times the vehicle is started on-off exceeds a set number of times when the freezing stage of the intercooler corresponds to the lower freezing stage.

11. The device of claim 1, wherein the condition monitoring data further includes at least one of starting on-off data of the vehicle, driving time data of the vehicle, parking time data of the vehicle, or boost pressure data corresponding to intake pressure of the intercooler, and
wherein the temperature data includes outside temperature data corresponding to an external temperature of the intercooler and intercooler outlet temperature data corresponding to an outlet temperature of the intercooler.

12. A vehicle comprising:
a device for monitoring freezing of an intercooler in a vehicle comprising a controller;
an engine combusting by mixing fuel with intake air;
an intercooler disposed to cool the intake air;
an intake line supplying the intake air to the engine;
an exhaust line through which exhaust gas discharged from the engine flows;
an Exhaust Gas Recirculation (EGR) device having an EGR line branched from the exhaust line and joined to the intake line;
an EGR cooler installed on the EGR line; and
a turbocharger compressing the intake air formed by joining a portion of the exhaust gas flowing through the EGR line and fresh air, while being rotated by the exhaust gas,
wherein the intercooler is disposed on the intake line and cools the intake air compressed by the turbocharger, and
wherein the controller is configured to:
receive condition monitoring data including temperature data of a sensor unit of the vehicle including the intercooler;
determine and change a degree of freezing progress of a plurality of freezing stages based on a process in which freezing progresses in the intercooler, according to the condition monitoring data; and
output the intercooler freezing monitoring data based on the degree of freezing progress.

13. A method of monitoring freezing of an intercooler in a vehicle, the method comprising:
receiving condition monitoring data including temperature data of a sensor unit of the vehicle including the intercooler;
determining and changing a degree of freezing progress of a plurality of freezing stages based on a process in which freezing progresses in the intercooler according to the condition monitoring data;
outputting intercooler freezing monitoring data based on the degree of freezing progress.

14. The method of claim 13, wherein a first freezing stage among the plurality of freezing stages includes a condensate generation stage in which condensate is generated in the intercooler or a lower freezing stage in which a lower portion of the intercooler is frozen,
wherein a second freezing stage among the plurality of freezing stages includes an outlet freezing stage in which an outlet of the intercooler is frozen or a boost pressure reduction stage in which an intake pressure of the intercooler is reduced, and
wherein the method further comprises:
determining the degree of freezing progress based on a freezing stage of the intercooler among the plurality of freezing stages;
selectively changing the degree of freezing progress so as to change the freezing stage of the intercooler to a next stage of the condensate generation stage or the lower freezing stage according to the condition monitoring data, when the freezing stage of the intercooler corresponds to the first freezing stage; and
outputting the intercooler freezing monitoring data based on the condition monitoring data when the freezing stage of the intercooler corresponds to the second freezing stage.

15. The method of claim 14, wherein the first freezing stage among the plurality of freezing stages includes the condensate generation stage, and
wherein the method further comprises selectively changing the degree of freezing progress so as to change the freezing stage of the intercooler to a next stage of the condensate generation stage based on whether an accumulated driving time of the vehicle while the temperature data is within a set temperature range exceeds a first set time, when the freezing stage of the intercooler corresponds to the condensate generation stage.

16. The method of claim 14, wherein the first freezing stage among the plurality of freezing stages includes the lower freezing stage, and
wherein the method further comprises:
selectively changing the degree of freezing progress so as to change the freezing stage of the intercooler to a next stage of the lower freezing stage based on whether a time that the vehicle is turned off while the temperature data is a freezing-possible temperature exceeds a second set time, when the freezing stage of the intercooler corresponds to the lower freezing stage.

17. The method of claim 14, wherein the temperature data includes intercooler outlet temperature data corresponding to an outlet temperature of the intercooler,
wherein the condition monitoring data includes boost pressure data corresponding to an intake pressure of the intercooler, and
wherein to the method further comprises:
outputting intercooler freezing monitoring data corresponding to an intercooler freezing warning based on whether an intercooler outlet temperature is a freezing-possible temperature and a boost pressure is lower than a set pressure, when the freezing stage of the intercooler corresponds to the second freezing stage.

18. The method of claim 14, wherein the method further comprises:
selectively changing the degree of freezing progress so as to control the freezing stage of the intercooler to return to a previous stage based on whether the condition monitoring data satisfies a regression condition of freezing progress degree.

19. A storage medium comprising at least one program recorded thereon, the at least one program including instructions for executing the method of monitoring freezing of an intercooler in a vehicle of claim 13.
